(19) United States
(12) Patent Application Publication
(10) Pub. No.: US 2004/0208615 A1
(43) Pub. Date: Oct. 21, 2004

(54) Clock recovery system and method

(76) Inventor: Peter Kean, Basingbourn (GB)

Correspondence Address: William M. Lee, Jr., Lee, Mann, Smith, McWilliams, Sweeney & Ohlson, P.O. Box 2786, Chicago, IL, 60690, US

(21) Appl. No.: 10/109,241

(22) Filed: Mar. 28, 2002

(51) Int. Cl. H04B 10/00; H04B 10/06

(52) U.S. Cl. 398/155

(57) ABSTRACT

In a high bit rate optical communications system, a clock signal is recovered from a received optical data signal by comparison of the data signal with an optical pulse stream derived from a local oscillator running at a sub-multiple of the signal bit rate. The oscillator forms part of a phase locked loop, and the signal comparison is made via a two photon absorber element which responds to a combination of the photon energies of the data signal and the locally generated pulse signal. The oscillator output is then used as a local clock for de-multiplexing purposes.

### FIELD OF THE INVENTION

This invention relates to apparatus and methods for clock recovery in a high speed data transmission system.

### BACKGROUND OF THE INVENTION

Increasing volumes of communications traffic, including both voice and data, are transported in the optical domain in a time division multiplexed (TDM) format. Th TDM traffic undergoes a number of stages of multiplexing, as defined in the SONET or SDH standards, and the resulting high bit rate signal is modulated on to an optical carrier for transport over an optical wave-guide or fibre. This optical signal is converted at a receiver to a corresponding electrical signal which can th n be de-multiplexed to recover individual channels. It will be appreciated that, in order to achieve this de-multiplexing, it is necessary to synchronise a local clock at a receiver with the received signal in order to provide the necessary timing information. It will also be appreciated that, as higher degrees of multiplexing are attained in order to provide increased traffic handling capacity, there will be an attendant increase in the signal bit rate.

In a conventional receiver system, a high-speed photo diode detects the data signal, and a phase locked loop or a band-pass filter is employed to extract the clock frequency which is then used as a local reference to de-multiplex the received signal and recover the individual channels.

In order to accommodate increasing values of traffic, a number of workers are investigating higher bit rate systems than are currently in use, for example, systems having a line rate of about 80 to 160 G/bit/second and above. It has been found that, at bit rates of this order, conventional clock recovery systems have insufficient bandwidth for processing the received signal at the line rate. The current approach to this problem has been a proposal to extract the clock signal at a sub-harmonic of the line rate, e.g. at one quarter of the line rate, so as to allow subsequent optical time domain de-multiplexing. However, this proposal as currently envisaged requires the use of a optical switch to provide de-multiplexing and mixing functions. Current optical switches do not have a sufficiently narrow switching window to perform this function effectively.

This lack of an effective method of clock recovery has restricted the introduction of high bit rate systems.

### OBJECT OF THE INVENTION

An object of the invention is to overcome or at least to mitigate the abov disadvantage.

A further object of the invention is to provide an improved method and apparatus for clock recovery in a high bit rate communications system.

### SUMMARY OF THE INVENTION

According to a first aspect of the invention there is provided a method of clock recovery at a receiver from an optical digital communications signal having a first wavelength, the method comprising generating at the receiver an optical pulse sequence of a second wavelength and having a bit rate equal to that of the data signal, and mixing the optical pulse sequence and the data signal via a two-photon absorption element so as to generate a output measure indicative of a bit rate and phase match between the optical pulse sequence and the optical data signal.

According to a second aspect of the invention, there is provided a method of clock recovery for an optical data signal in a digital communications system, the method comprising generating a local pulsed optical signal at a sub-multiple of the optical signal bit rate, receiving the local pulsed signal and the optical data signal via a two photon absorbed device and determining from an output signal from the two photon absorber device a measure of phase locking between the local oscillator and the optical data signal.

According to another aspect of the invention there is provided a clock recovery system for an optical communications system, the system comprising a two photon absorber device to which, in use, a received multiplexed data signal of a first wavelength and a second locally generated oscillator signal are fed, and means responsive to an output of the two photon absorber device for synchronising the oscillator with the received data signal so as to provide a local clock signal for de-multiplexing said data signal.

The two photon absorber device comprises a material having an appropriate band gap and may for example be selected from the group consisting of silicon avalanche photodiodes, gallium arsenide phosphide photodiodes, laser diodes and semiconductor amplifiers. In a preferred embodiment, the two photon absorption element comprises a silicon photodiode having a band gap that is greater than the photon energy of the data signal wavelength, but which is less than the combined photon energies of the data signal wavelength and the locally generated signal wavelength.

According to another aspect of the invention there is provided a clock recovery system for an optical communications system, the clock recovery system including an oscillator providing in use a local clock for de-multiplexing an optical data signal received by the clock recovery system, wherein the oscillator is arranged in a phase locked loop whose frequency and phase are determined by comparison in a two photon absorber element of optical pulses derived from the oscillator with the received data signal.

According to another aspect of the invention there is provided a method of synchronising an oscillator to an optical signal having a first wavelength and carrying information digitally encoded at a defined bit rate, the method comprising: generating from said oscillator a sequence of optical pulses of a second wavelength, mixing said pulses with the optical signal, detecting the mixed signal with a two photon absorption detector, and adjusting the frequency and phase of said oscillator responsive to the detector output so as to align said oscillator in frequency and phase with the optical signal.

The data signal wavelength may be derived from a single wavelength transmission system, or it may comprise a wavelength that has been “dropped” from a wavelength division multiplexed (WDM) transmission system.

Typically, the oscillator is run at a frequency corresponding to a sub-multiple of the signal bit rate, e.g. one quarter of that bit rate. The optical pulses derived from this oscillator frequency may then be multiplexed up to match the data signal bit rate.

In a preferred embodiment, the two photon absorber device comprises a first element for receiving the optical data signal mixed with the pulsed optical signal, and a second element for receiving only the optical data signal, said second element providing a reference for eliminating the effect of amplitude variations in the optical data signal.

The technique obviates the need for optical switching.

According to another aspect of the invention there is provided a method of de-multiplexing an optical data signal of a first wavelength at a receiver by locally generating a clock signal from the data signal, wherein said clock signal is derived from an oscillator synchronised with the data signal by generating from that oscillator a sequence of optical pulses of a second wavelength, mixing said pulses with the optical signal, detecting the mixed signal with a two photon absorption detector, and adjusting the frequency and phase of said oscillator responsive to the detector output so as to align said oscillator in frequency and phase with the optical signal.

De-multiplexing of the data signal may be performed in a network node e.g. as part of an add/drop arrangement.

### BRIEF DESCRIPTION OF THE DRAWINGS

Embodiments of the invention and the best known method of putting the invention into practice will now be described with reference to the accompanying drawings in which:

FIG. 1 shows in schematic form a clock recovery system according to a first embodiment of the invention,

FIG. 1a shows a modified detector construction for use in the clock recovery system of FIG. 1;

FIG. 2 illustrates the construction of a de-multiplexer for use with the clock recovery system of FIG. 1; and

FIG. 3 shows an alternative clock recovery system according to a second embodiment of the invention.

### DESCRIPTION OF PREFERRED EMBODIMENTS

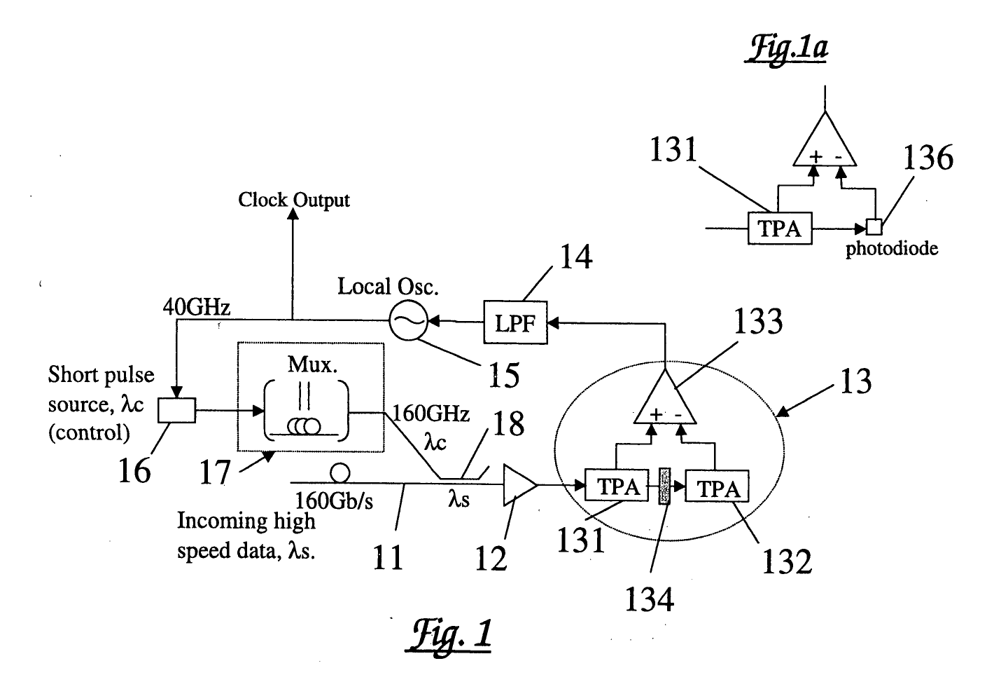

Referring to FIG. 1, this shows in schematic form the construction of a clock recovery system for use in an optical communications system. It will be appreciated that, for clarity, only those parts of the clock recovery system that are necessary for the understanding of the invention are shown in FIG. 1. The received optical data signal having a wavelength λs, typically 1.3 microns, on transmission fibre 11 is fed via amplifier 12 to a detector device 13. The output of the detector device 13 is fed via a low pass filter 14 to a local oscillator 15, e.g. a voltage controlled oscillator, running at a frequency which is a sub-multiple, typically one quarter, of the incoming data bit rate. Thus, for a received data bit rate of e.g. 160 Gbit/s, the local oscillator will run at a frequency of 40 GHz. Typically, the receiver will be disposed in a network node (not shown). Typically, the data signal on fibre 11 will have been tapped off from a main fibre path as will be described below. The precise bit rate of the data signal will of course be defined by the appropriate SONET or SDH standards.

The local oscillator 15 drives a short pulse source 16 which generates optical pulses at a wavelength of λc, typically 1.55 microns, and at a rate of 40 G bit/sec, i.e. a sub-multiple of the data signal bit rate. The pulse source 16 may comprise a semiconductor laser. The pulse source output is preferably multiplexed by multiplexer 17 up to a bit rate of 160 Gbit/second, i.e. a rate equal to the signal bit rate, and this ‘control’ signal of wavelength λc is mixed with the data signal of wavelength λs at the input to amplifier 12 via coupler 18.

As shown in FIG. 1, the detector 13 comprises first and second two-photon absorber devices 131, 132 whose outputs are coupled to the respective non-inverting and inverting inputs of differential amplifier 133. A blocking filter 134 tuned to the ‘control’ or reference signal wavelength λc is disposed between the first and second two-photon absorption elements 131, 132.

Each two-photon absorption element comprises a material, e.g. silicon or gallium arsenide which provides an electrical output signal on absorption of a first photon at the data signal wavelength λs and a second photon at the control signal wavelength λc. The control signal wavelength is similar to but not identical with the data signal wavelength. For example, the data signal may have a wavelength λs typically of 1.55 microns and the control signal may have a wavelength λc within the range 1.53 microns and 1.60 microns.

The purpose of the blocking filter 134, which blocks the reference signal wavelength, and the second two-photon absorption element 132 is to overcome the effect of amplitude variation of the received optical data signal. Although absorption of two photons of respective wavelengths λs and λc is the dominant effect, absorption of pairs of photons both of wavelength λs can take place. This unwanted effect is masked out by connecting the output of the second two-photon absorption element to the inverting input of the differential amplifier 133

In use, the oscillator frequency and phase are controlled by the output current from the detector 13. The arrangement constitutes a phase locked loop in which, under steady state conditions, the control signal derived from the oscillator will have the same bit rate and will be in phase with the received data signal, so that the oscillator can then be used as a local reference source as a clock for de-multiplexing the data signal. Conveniently, the oscillator 15 is a voltage controlled oscillator whose frequency and phase are determined by the feedback signal from the detector 13.

In some applications, the multiplexer 17 may be dispensed with. The 40 Gbit/second pulse stream from the short pulse source is then synchronised with every fourth pulse of the 160 Gbit/second data signal.

The two photon absorption elements may each comprise a silicon avalanche photodiode, a gallium arsenide phosphide photodiode, a laser diode or a semiconductor amplifier. Those skilled in the art will be familiar with the construction of these devices. The semiconductor material may be formed into a wave guide. Preferably, the semiconductor has a band gap that is greater than the photon energy of the received data signal (λs) but is less than twice that photon energy. It is not essential to employ a semiconductor material, and other materials having a suitable band gap and optical properties may be employed.

FIG. 1a shows an alternative detector construction requiring only a single two photon detector element. In this arrangement, a photo diode 136 provides the reference output to the differential amplifier 133 for suppressing the effect of amplitude variation in the received data signal.

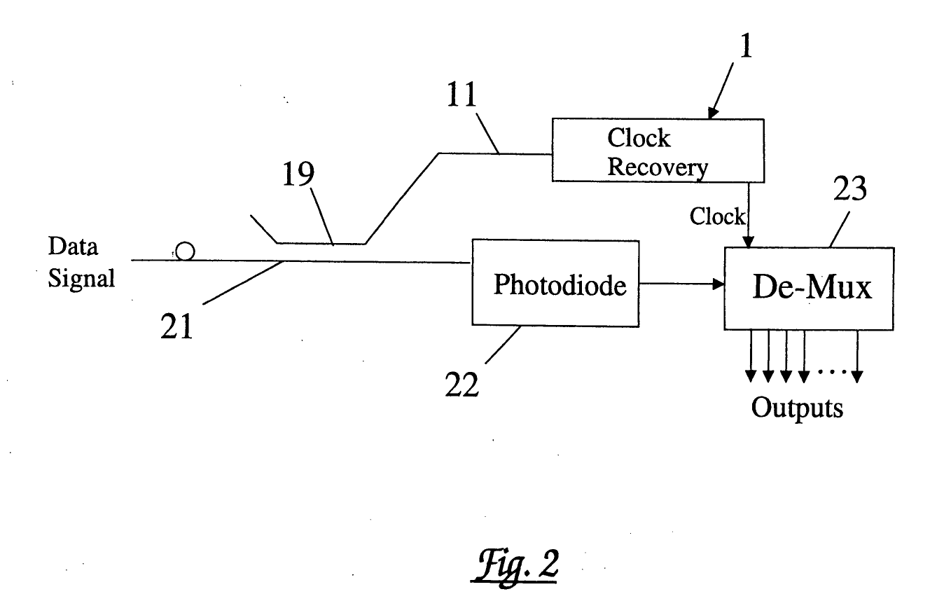

FIG. 2 illustrates the manner in which the locally extracted clock signal is employed to de-multiplex the data signal. As shown schematically in FIG. 2, the optical data signal is received on transmission fibre 20 from which a portion of that signal is tapped off via coupler 19 and fibre 11 to provide the input to the clock recovery system 1. The signal on the fibre 20 is converted to a corresponding electrical signal via photodiode 22, and this electrical signal is then de-multiplexed in de-multiplexer 23 using the locally generated clock as a timing reference.

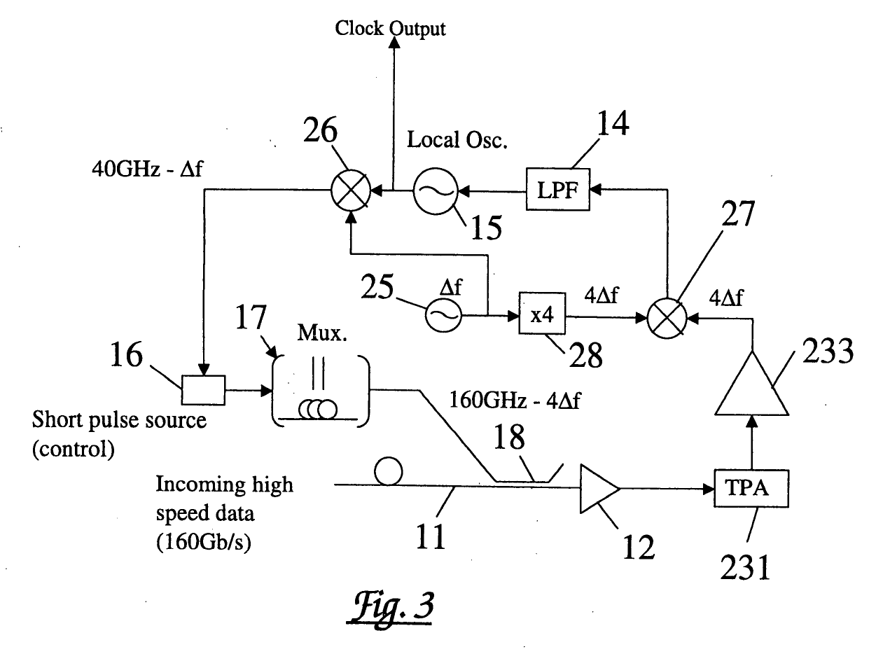

Referring now to FIG. 3, this shows an alternative receiver system which requires only a single TPA detector element 231. In the phase locked loop arrangement of FIG. 3, the output of the local 40 GHz oscillator 15 is mixed via mixer 26 with th output from a second, low frequency oscillator 25 (Δf) so as to provide a reference signal of frequency 40 GHz-Δf to the short pulse source 16. The resulting pulse output at wavelength λc from the short pulse source 16 is multiplexed up by multiplexer 17 to an optical reference signal at a bit rate of 160−4Δf Gbit/s, and is mixed with the incoming data signal (λs) via coupler 18. The output from the detector 231 and amplifier 233 comprises a signal that is amplitude modulated with the frequency 4Δf.

The 4Δf output from the detector amplifier 233 is mixed in mixer 27 with a reference signal (4Δf) derived from the local oscillator 25 via frequency multiplier 28 so as to generate direct current signal whose magnitude is a measure of the phase relationship between thee two 4Δf signals. This direct current signal is fed back to the oscillator 15 via low pass filter 14 so as to provide a control signal that locks the oscillator in phase with the data signal.

It will be understood that the above description of preferred embodiments is given by way of example only and that various modifications may be made by those skilled in the art without departing from the spirit and scope of the invention.

1. A method of clock recovery from an optical digital communications signal having a first wavelength received at a receiver, the method comprising generating at the receiver an optical pulse sequence of a second wavelength and having a bit rate equal to that of the data signal, and mixing the optical pulse sequence and the data signal via a two-photon absorption element so as to generate a output measure indicative of a bit rate and phase match between the optical pulse sequence and the optical data signal.

2. A method of clock recovery from an optical data signal in a digital communications system, the method comprising generating from a local oscillator a pulsed optical signal at a sub-multiple of the optical signal bit rate, receiving the local pulsed signal and the optical data signal via a two photon absorbed device and determining from an output signal from the two photon absorber device a measure of phase locking between the local oscillator at the optical data signal.

3. A method as claimed in claim 2, wherein the pulsed optical signal is multiplexed with itself to provide a bit rate equal to that of the optical data signal.

4. A method as claimed in claim 3, wherein the local oscillator output is mixed with a low frequency signal, and wherein said low frequency signal provides a phase reference for synchronising the local oscillator with the data signal.

5. A method as claimed in claim 4, wherein said local oscillator is a voltage controlled oscillator arranged in a phase locked loop

6. A method as claimed in claim 5, wherein said optical data signal comprises one wavelength of a plurality wavelengths in a wave division multiplexed transmission system.

7. A method as claimed in claim 6, wherein said two photon absorber device comprises a first element for receiving the optical data signal mixed with the pulsed optical signal, and a second element for receiving only the optical data signal, said second element providing a reference for eliminating the effect of amplitude variations in the optical data signal.

8. A clock recovery system for an optical communications system, the system comprising a two photon absorber device to which, in use, a received multiplexed data signal of a first wavelength and a second locally generated oscillator signal are fed, and phase locked loop means responsive to an output of the two photon absorber device for synchronising the oscillator with the received data signal so as to provide a local clock signal for de-multiplexing said data signal.

9. A clock recovery system as claimed in claim 8, wherein the local oscillator output is mixed with a low frequency signal, and wherein said low frequency signal provides a phase reference for synchronising the local oscillator with the data signal.

10. A clock recovery system as claimed in claim 9, wherein said local oscillator is a voltage controlled oscillator arranged in a phase locked loop

11. A clock recovery system as claimed in claim 10, wherein said optical data signal comprises one wavelength of a plurality wavelengths in a wave division multiplexed transmission system.

12. A clock recovery system as claimed in claim 11, wherein said two photon absorber device comprises a first element for receiving the optical data signal mixed with the pulsed optical signal, and a second element for receiving only the optical data signal, said second element providing a reference for eliminating the effect of amplitude variations in the optical data signal.

13. A clock recovery system as claimed in claim 12 wherein said two photon absorber device is selected from the group consisting of silicon avalanche photodiodes, gallium arsenide phosphide photodiodes, laser diodes and semiconductor amplifiers.

14. A de-multiplexer incorporating a clock recovery system as claimed in claim 8.

15. A communications network node incorporating a clock recovery system as claimed in claim 8.

16. A method of synchronising an oscillator to an optical signal having a first wavelength and carrying information digitally encoded at a defined bit rate, the method comprising: generating from said oscillator a sequence of optical pulses of a second wavelength, mixing said pulses with the optical signal, detecting the mixed signal with a two photon absorption detector, and adjusting the frequency and phase of said oscillator so as to maximise the detector output and thereby align said oscillator in frequency and phase with the optical signal.

17. A method of de-multiplexing an optical data signal of a first wavelength at a receiver by locally generating a clock signal from the data signal, wherein said clock signal is derived from an oscillator synchronised with the data signal by generating from that oscillator a sequence of optical pulses of a second wavelength, mixing said pulses with the optical signal, detecting the mixed signal with a two photon absorption detector, and adjusting the frequency and phase of said oscillator responsive to the detector output so as to align said oscillator in frequency and phase with the optical signal.
